(19) United States
(12) Patent Application Publication
(10) Pub. No.: US 2024/0393529 A1
(43) Pub. Date: Nov. 28, 2024

(54) INTEGRATED SLOT WAVEGUIDE OPTICAL PHASE MODULATOR

(71) Applicant: SHANGHAI XIZHI TECHNOLOGY CO., LTD., Shanghai (CN)

(72) Inventors: Huaiyu MENG, Medford, MA (US); Yichen SHEN, Cambridge, MA (US); Zhan SU, Boston, MA (US)

(73) Assignee: SHANGHAI XIZHI TECHNOLOGY CO., LTD., Shanghai (CN)

(21) Appl. No.: 18/696,297

(22) PCT Filed: Sep. 30, 2021
(86) PCT No.: PCT/CN2021/122159

§ 371 Date: Mar. 27, 2024

(51) Int. Cl. G02B 6/12; G02B 6/134; G02F 1/225

(52) U.S. Cl. CPC G02B 6/12004; G02F 1/2257; G02B 2006/12142; G02B 2006/12159; G02B 6/134; G02F 2203/50

(57) ABSTRACT

An apparatus for modulating an optical wave includes a slot waveguide structure that includes: a first higher-index structure doped to include a region that has a first conductivity type, a second higher-index structure doped to include a region that has the first conductivity type, and one or more slot regions between the first and second higher-index structures. The one or more slot regions have a lower index of refraction than the first and second higher-index structures. The apparatus includes a first support structure. The first support structure is doped to include a region that has a second conductivity type different from the first conductivity type. The apparatus includes a second support structure. The second support structure is doped to include a region that has the second conductivity type.

### TECHNICAL FIELD

This disclosure relates to an integrated slot waveguide optical phase modulator.

### BACKGROUND

An optical phase modulator is a device that is able to vary the phase of an optical signal propagating through the modulator. For example, an optical phase modulator is configured to vary the phase of an eigenmode propagating in a waveguide by varying the refractive index of a material within the waveguide, such as the core of the waveguide. Optical phase modulators can be used within other devices, such as an optical amplitude modulator that uses an optical phase modulator in one or both arms of a Mach-Zehnder interferometer.

### SUMMARY

In a general aspect, an apparatus for modulating an optical wave is provided. The apparatus includes: a slot waveguide structure that includes: a first higher-index structure doped to include a region that has a first conductivity type, a second higher-index structure doped to include a region that has the first conductivity type, and one or more slot regions between the first higher-index structure and the second higher-index structure that consist essentially of a gas, a liquid, or a viscous material having a lower index of refraction than the first higher-index structure and the second higher-index structure. The apparatus includes a first support structure configured to support the first higher-index structure and to enable the first higher-index structure to move to change a dimension of at least one of the one or more slot regions, where the first support structure is doped to include a region that has a second conductivity type opposite from the first conductivity type; and a second support structure configured to support the second higher-index structure and to enable the second higher-index structure to move to change a dimension of at least one of the one or more slot regions, where the second support structure is doped to include a region that has the second conductivity type.

Implementations can include one or more of the following features. The slot waveguide structure can include a multiple-slot waveguide structure in which one or more slot regions include two or more slot regions.

The slot waveguide structure can further include: a third higher-index structure that is substantially undoped between the first higher-index structure and the second higher-index structure.

The first support structure is configured to enable the first higher-index structure to move to change a dimension of a slot region between the first higher-index structure and the third higher-index structure; and the second support structure is configured to enable the second higher-index structure to move to change a dimension of a slot region between the second higher-index structure and the third higher-index structure.

The apparatus can further include: an input coupling structure configured to receive the optical wave and to provide coupling between a spatial mode of the optical wave and an eigenmode of the slot waveguide structure; and an output coupling structure that is configured to provide coupling between the eigenmode of the slot waveguide structure and a spatial mode of a modulated optical wave that has been modulated based at least in part on a change in dimension of at least one of the one or more slot regions during propagation of the optical wave through the slot waveguide structure.

The doped region of the first higher-index structure and the doped region of the second higher-index structure can have substantially equal doping concentrations.

The doped region of the first support structure and the doped region of the second support structure can have substantially equal doping concentrations.

The doped region of the first support structure can be electrically coupled to a first electrode, and the doped region of the second support structure can be electrically coupled to a second electrode.

The apparatus can further include a voltage source configured to provide a voltage between the first electrode and the second electrode to cause movement that changes a dimension of at least one of the one or more slot regions.

The slot waveguide structure can include a portion of an arm of an interferometric structure.

The apparatus can include an interferometric structure, in which the slot waveguide structure is a portion of an arm of the interferometric structure.

The slot waveguide structure can be configured to modulate a phase of an optical wave propagating in the arm of the interferometric structure.

The interferometric structure can be configured to modulate an amplitude of an amplitude of an optical wave propagating in the interferometric structure.

The interferometric structure can include a Mach-Zehnder interferometer.

The first higher-index structure and the first support structure can form an integrated structure.

The second higher-index structure and the second support structure can form an integrated structure.

The first higher-index structure, the second higher-index structure, the first support structure, and the second support structure can form an integrated structure.

The first support structure and the second support structure can form an integrated structure.

In another general aspect, an apparatus includes: a slot waveguide structure that includes: two or more higher-index structures each doped to include a region that has a first conductivity type, and one or more slot regions between the two or more higher-index structures having a lower index of refraction as compared to that of the two or more higher-index structures. The apparatus includes support structures configured to support corresponding higher-index structures and to enable the corresponding higher-index structures to move to change a dimension of at least one of the one or more slot regions, in which each support structure is doped to have a second conductivity type that is opposite the first conductivity type.

Implementations can include the following feature. The apparatus can include electrodes configured to enable a voltage to be applied across the region in the high-index structure that is doped to have a first conductivity type and the region in the corresponding support structure that is doped to have the second conductivity type.

In another general aspect, a system includes: a processor unit that includes: a light source configured to provide a plurality of light outputs; and a plurality of optical modulators coupled to the light source and the first unit. The plurality of optical modulators are configured to generate an optical input vector by modulating the plurality of light outputs provided by the light source based on a plurality of modulator control signals. The optical input vector includes a plurality of optical signals. The processor unit includes a matrix multiplication unit coupled to the plurality of optical modulators, the matrix multiplication unit being configured to transform the optical input vector into an output vector based on a plurality of weight control signals. At least one of the optical modulators includes any of the apparatuses for modulating an optical wave described above.

Implementations can include the following feature. Each of the optical modulators can include any of the apparatuses described above.

In another general aspect, an optical processor that includes a plurality of optical modulators, in which at least one of the optical modulators includes any of the apparatuses described above.

Implementations can include the following feature. Each of the plurality of optical modulators can include any of the apparatuses described above.

In another general aspect, a system includes at least one of a robot, an autonomous vehicle, an autonomous drone, a medical diagnosis system, a fraud detection system, a weather prediction system, a financial forecast system, a facial recognition system, a speech recognition system, or a product defect detection system. The at least one of a robot, an autonomous vehicle, an autonomous drone, a medical diagnosis system, a fraud detection system, a weather prediction system, a financial forecast system, a facial recognition system, a speech recognition system, or a product defect detection system can include any of the apparatuses described above.

In another general aspect, a method for fabricating an optical modulator is provided. The method includes: forming a slot waveguide structure that includes: a first higher-index structure, a second higher-index structure, and one or more slot regions between the first higher-index structure and the second higher-index structure that consist essentially of a gas, a liquid, or a viscous material having a lower index of refraction than the first higher-index structure and the second higher-index structure. The method includes forming a first support structure configured to support the first higher-index structure and to enable the first higher-index structure to move to change a dimension of at least one of the one or more slot regions; forming a second support structure configured to support the second higher-index structure and to enable the second higher-index structure to move to change a dimension of at least one of the one or more slot regions; doping the first higher-index structure to include a region that has a first conductivity type; doping the second higher-index structure to include a region that has the first conductivity type; doping the first support structure to include a region that has a second conductivity type opposite from the first conductivity type; and doping the second support structure to include a region that has the second conductivity type.

Implementations can include one or more of the following features. Forming the slot waveguide structure can include: forming a plurality of holes within a portion of the first support structure, forming a plurality of holes within a portion of the second support structure, and providing a gas through at least some of the plurality of holes to etch a portion of material from which the first higher-index structure and the second higher-index structure are formed, to enable movement of the first higher-index structure and the second higher-index structure.

The doping of the first higher-index structure, the second higher-index structure, the first support structure, and the second support structure can occur before the plurality of holes are formed within portions of the first and second support structures.

In another general aspect, a method of modulating an optical wave is provided, the method includes propagating an optical wave along a slot waveguide structure that includes: two or more suspended waveguide core structures that define one or more slot regions between the suspended waveguide core structures; and modulating the optical wave by generating an electromagnetic force to cause the two or more suspended waveguide core structures to move and modify a dimension of the one or more slot regions between the suspended waveguide core structures and modify an effective refractive index of the slot waveguide structure.

Implementations can include one or more of the following features. The slot waveguide structure can include support structures each configured to support a respective suspended waveguide core structure. Generating the electromagnetic force can include generating a repulsion force to cause a suspended waveguide core structure to move away from the corresponding support structure.

The slot waveguide structure can include support structures each configured to support a respective suspended waveguide core structure. Generating the electromagnetic force can include generating an attractive force to cause a suspended waveguide core structure to move towards the corresponding support structure.

Each suspended waveguide core structure can include a region that is doped to have a first conductivity type, and the corresponding support structure can include a region that is doped to have a second conductivity type that is opposite the first conductivity type.

In another general aspect, an apparatus includes: a slot waveguide structure that includes: a first higher-index structure doped to include a region that has a first conductivity type, a second higher-index structure doped to include a region that has the first conductivity type, and one or more slot regions between the first higher-index structure and the second higher-index structure that have a lower index of refraction than the first higher-index structure and the second higher-index structure. The apparatus includes a first support structure configured to support the first higher-index structure and to enable the first higher-index structure to move to change a dimension of at least one of the one or more slot regions, where the first support structure is doped to include a region that has a second conductivity type different from the first conductivity type. The apparatus includes a second support structure configured to support the second higher-index structure and to enable the second higher-index structure to move to change a dimension of at least one of the one or more slot regions, where the second support structure is doped to include a region that has the second conductivity type.

Aspects can have one or more of the following advantages.

By doping certain portions of a slot waveguide structure and other supporting structures of an optical phase modulator, the modulation efficiency can be improved such that a relatively low driving voltage can be used to change the size of one or more slots of the slot waveguide structure. For example, in some embodiments, structures that provide electromechanical support (also referred to herein as “supports”) within a micro-electromechanical system (MEMS) structure are doped using certain dopants. Waveguide cores suspended by the supports can be doped with same dopants and thus the same electron or hole carrier type (also called conductivity type), and the supports can be doped to have opposite electron or hole carrier type as the suspended waveguide cores. The resulting forces that arise upon application of an electric field using a driving voltage include an attractive force that attract the suspended waveguide cores to their respective supports, and a repulsive force between the suspended waveguide cores. These forces enable the optical phase modulator to be more efficient and thus require a lower driving voltage.

The details of one or more embodiments of the subject matter described in this specification are set forth in the accompanying drawings and the description below. Other features, aspects, and advantages of the invention will become apparent from the description, the drawings, and the claims.

Unless otherwise defined, all technical and scientific terms used herein have the same meaning as commonly understood by one of ordinary skill in the art to which this invention belongs. In case of conflict with patent applications or patent application publications incorporated herein by reference, the present specification, including definitions, will control.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A, 1B and 2 are schematic diagrams of an example implementation of an optical phase modulator.

FIG. 3A is a schematic diagram showing an electrode structure for the optical phase modulator of FIGS. 1A, 1B.

FIG. 3B is a schematic diagram of a cross-sectional view of structures within the optical phase modulator of FIGS. 1A, 1B.

FIGS. 4A-4C are schematic diagrams of example implementations of slot waveguide structures with different numbers of slots.

FIG. 5 is a flowchart for an example fabrication procedure.

Like reference numbers and designations in the various drawings indicate like elements.

### DETAILED DESCRIPTION

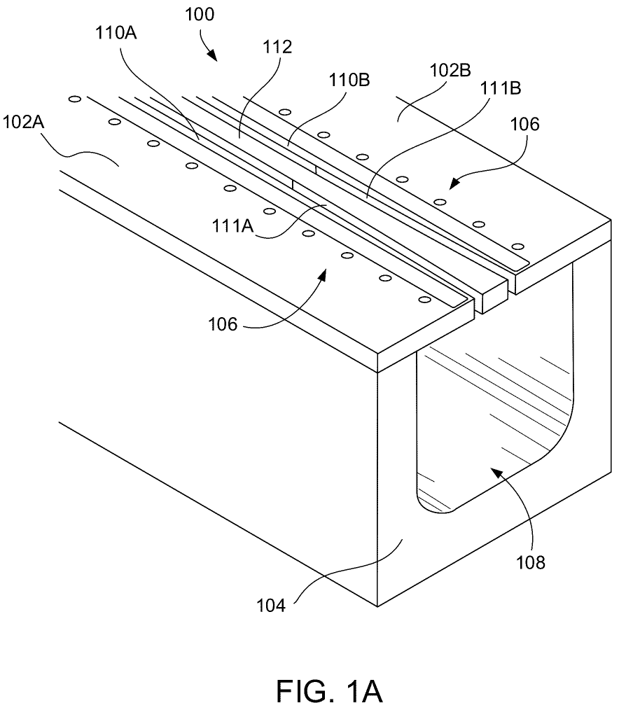

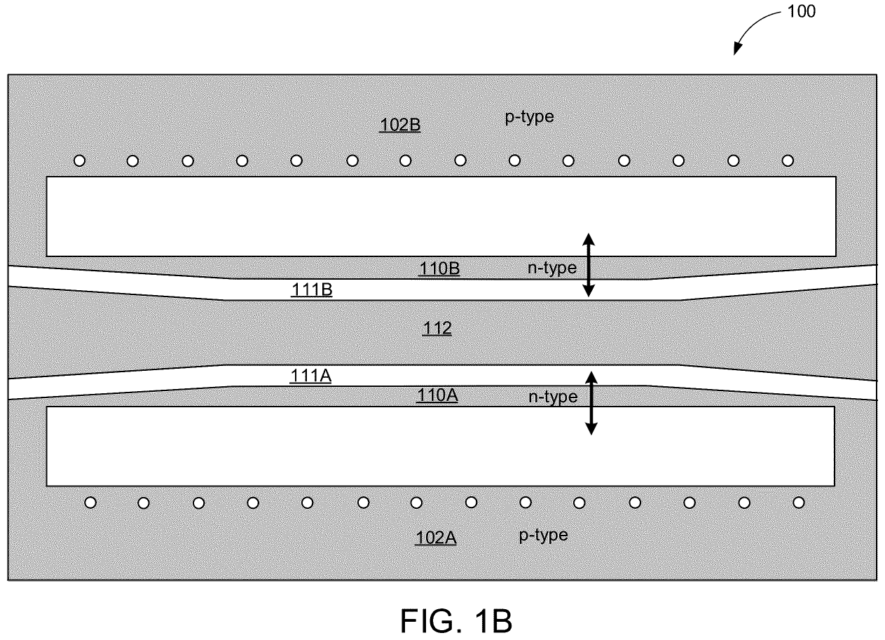

Referring to FIG. 1A, an example optical phase modulator 100 includes two supports 102A and 102B. The supports 102A, 102B are fixed at a certain position by a base structure 104 on which the supports 102A and 102B are formed. For example, there can be a solid block of material (e.g., formed from a monocrystalline silicon material) with holes 106 formed along the top surface to allow a gas to be passed through in a process of etching away a hollow central cavity 108 underneath, and/or other portions of the structures described herein.

In some embodiments, the supports 102A and 102B are attached to the base structure 104 without requiring the holes 106 to be formed. There are also lateral waveguide core structures 110A and 110B that are suspended by being attached at their ends to the respective supports 102A and 102B. There is also a center waveguide core structure 112 between the lateral waveguide core structures 110A and 110B that is attached at a different portion of the modulator (not shown). The regions between the lateral waveguide core structures 110A and 110B and the center waveguide core structure 112 are called slot regions, or simply “slots.” This is an example of a multiple-slot waveguide structure (a 2-slot waveguide structure in particular) since there are two narrow slots 111A and 111B between the center waveguide core and each of the two lateral waveguide cores 110A and 110B, respectively, in which significant optical energy is contained in the eigenmode that is guided. An optical wave modulated by the modulator 100 travels in a direction parallel to the longitudinal direction of the center waveguide core structure 112, and the optical energy is contained the center waveguide core structure 112, the slots 111A and 111B, and the lateral waveguide core structures 110A, 110B. The effective refractive index changes in response to changes in the dimensions (e.g., width) of the slots 111A, 111B. In some examples, large portions of the optical energy are contained in the slots 111A and 111B, and the effects of the changes in the dimensions of the slots to the optical wave can be significant.

The modulator 100 includes an input coupling structure (not shown in the figure) that is configured to receive the optical wave and to provide coupling between a spatial mode of the optical wave and an eigenmode of the slot waveguide structure. The modulator 100 also includes an output coupling structure (not shown in the figure) that is configured to provide coupling between the eigenmode of the slot waveguide structure and a spatial mode of a modulated optical wave that has been modulated based at least in part on a change in dimension of at least one of the one or more slot regions during propagation of the optical wave through the slot waveguide structure.

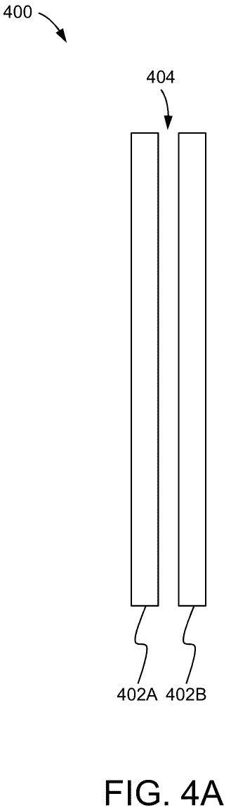

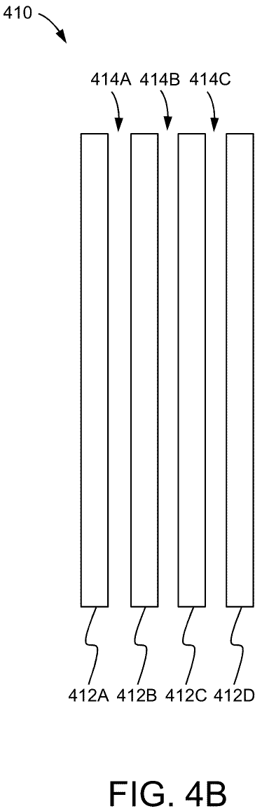

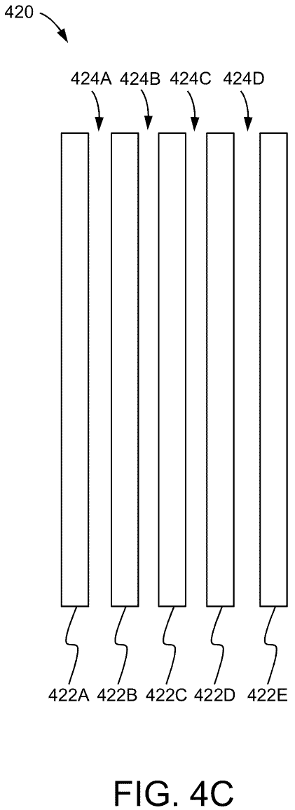

To allow movement of the lateral waveguide core structures so that the corresponding change in dimensions of the slots changes the effective index of this eigenmode, these slots can be free of any impediments (or have reduced impediments) to such movement. For example, the slots can include essentially of air or other gas, a liquid, or a viscous material. Also, any such gas, liquid, or viscous material can have a lower index of refraction than the material from which the waveguide core structures are formed (e.g., silicon or other semiconductor material that can be doped). Alternatively, other examples can have more than two slots, or only a single slot, depending on how many waveguide core structures are included in the overall modulator device, as described below with reference to FIGS. 4A-4C.

In some implementations, etching is used to form the slot between the lateral waveguide core structure 110A and the center waveguide core structure 112, and the slot between the lateral waveguide core structure 110B and the center waveguide core structure 112. Etching is also used to form the open space between the lateral waveguide core structure 110A and the adjacent support 102A, and the open space between the lateral waveguide core structure 110B and the adjacent support 102B.

The lateral waveguide core structures 110A and 110B are doped with the same dopants as each other having a particular electron or hole charge carrier type, also called a conductivity type. For example, an n-type dopant or impurity can be used to provide donor electrons for an electron charge carrier type (or electron conductivity type). The supports 102A and 102B are doped with the same dopants as each other, but opposite carrier type compared to the dopants for the lateral waveguide cores structures 110A and 110B. For example, a p-type dopant or impurity that is an electron acceptor can be used for a hole charge carrier type (or hole conductivity type).

For example, referring to FIG. 1B showing a top view of a portion of the optical phase modulator 100 (at a different scale for ease of viewing), the supports 102A and 102B can be doped with p-type dopants, and the lateral waveguide cores structures 110A and 110B can be doped with n-type dopants. As another example, the supports 102A and 102B can be doped with n-type dopants, and the lateral waveguide cores structures 110A and 110B can be doped with p-type dopants. When an electric field is applied, as described in more detail below, the lateral waveguide core structures 110A and 110B are repelled from each other and attracted to their respective supports 102A and 102B. The center waveguide core structure 112 is undoped and thus does not move in response to the applied electric field. These electromagnetic repulsion and attraction forces enable the widths of the slots to vary in an efficient manner (e.g., in some cases more efficient than mechanical forces used in other devices). In some implementations, the doping concentrations for the p-type and n-type dopants can be substantially equal in the waveguide core structures and the adjacent supports. In some fabrication procedures, the doping of portions of the material occurs before the holes 106 are formed to enable the structures to be fully formed.

For example, a multi-slot waveguide nano-opto-electromechanical phase modulator uses a slot waveguide structure that has an effective refractive index for an eigenmode that varies based on the size of gaps between suspended waveguide cores. The modulator is driven using mechanical drivers that drive movements of the suspended waveguide cores in order to change the dimensions of the slots. The suspended waveguide cores can be made of an undoped, or low-doped, semiconductor material. Compared to such a multi-slot waveguide nano-opto-electromechanical phase modulator, the optical phase modulator 100 (or 200) uses electro and/or electromagnetic repulsion and attraction forces to vary the widths of the slot or slots in a more efficient manner.

In some implementations, the supports 102A, 102B are relatively close to the lateral waveguide core structures 110A, 110B, so the attraction force between them (due to the opposite charge) will be relatively large. Therefore, the voltage needed to achieve the width variation of the slots (due to deformation of the lateral waveguide cores structures) is relatively low. For example, there can be a relatively low voltage that is required to achieve a particular modulation efficiency compared to a voltage that would be used to modulate a piezoelectric driver that would be used to apply a mechanical force.

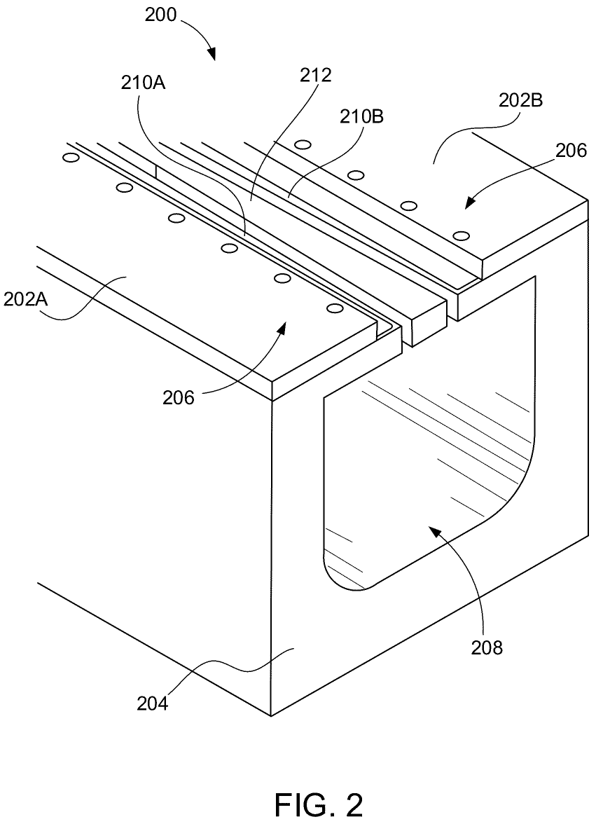

Referring to FIG. 2, another example optical phase modulator 200 includes two supports 202A and 202B. The supports are fixed at a certain position by a base structure 204 on which the supports 202A and 202B are formed. In this example, the supports 202A and 202B are formed by applying a layer of another material (e.g., a poly-silicon layer) different from the material of the base structure 204 (e.g., a monocrystalline silicon material). Alternatively, there can be a solid block of material with holes 206 formed along the top surface to allow a gas to be passed through in a process of etching away a hollow central cavity 208 underneath. There are also lateral waveguide core structures 210A and 210B that are suspended by being attached at their ends to a support structure that includes both the respective supports 202A and 202B and a portion of the base structure 204. There is also a center waveguide core structure 212 between the lateral waveguide cores structures 210A and 210B that is attached at a different portion of the modulator (not shown). In this example, the poly-silicon supports 202A and 202B and the suspended waveguide core structures 210A and 210B are on different layers. There will still be an attraction force between the supports 202A, 202B and the respective suspended waveguide core structures 210A, 210B, though the force can be smaller than in the example of FIG. 1 since the supports 202A, 202B are not directly opposite to the suspended waveguide core structures 210A, 210B.

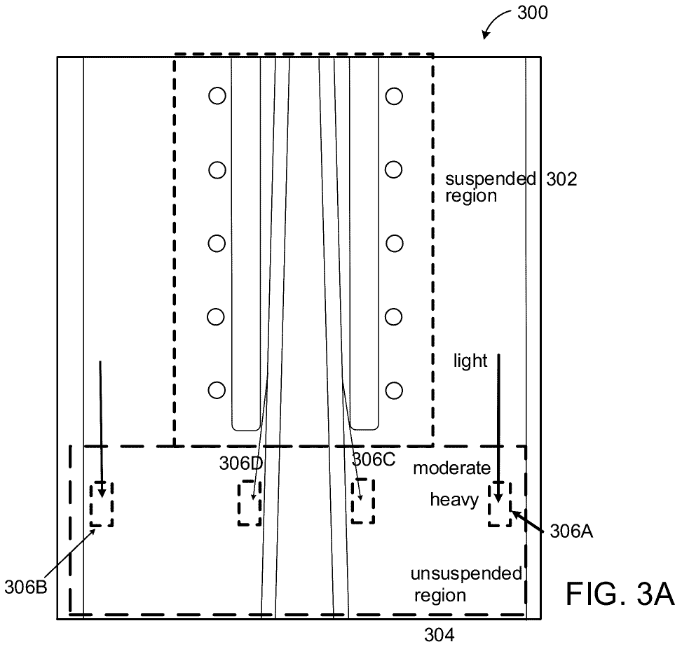

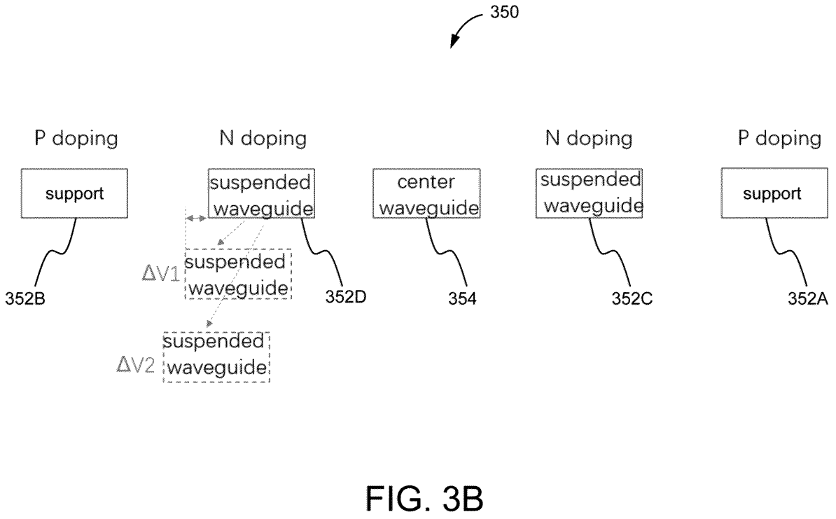

Referring to FIGS. 3A and 3B, a top view 300 shows different regions of a portion of an optical phase modulator, and a cross-sectional view 350 shows different structures of the optical phase modulator, which are electrically connected to anode and cathode contacts shown in the top view 300. The top view 300 shows a suspended region 302 that includes the suspended waveguide core structures and a portion of the supports on both sides, and an unsuspended region 304 that includes metal electrodes 306A-306D for making electrical contact to heavily doped regions underneath. In some implementations, the doping concentration changes from lightly doped portions of the suspended region 302 (e.g., to reduce associated loss experienced by the guided optical wave) to heavily doped portions of the unsuspended region 304 (e.g., for low contact resistance to the electrodes 306A-306D).

Referring to FIG. 3B, the cross-sectional view 350 shows the p-type doped supports 352A and 352B, the n-type doped suspended waveguide core structures 352C and 352D, and the undoped center waveguide core structure 354. For example, for the center waveguide core structure 112 (FIG. 1A, 1B) that extends along a longitudinal direction, the cross-sectional view 350 shows the relative positions of the p-type doped supports 352A and 352B, the n-type doped suspended waveguide core structures 352C and 352D, and the undoped center waveguide core structure 354 on a plane that is perpendicular to the longitudinal direction. The anode electrodes 306A and 306B make electrical connection to the heavily to lightly doped regions that extend to the p-type doped supports 352A and 352B, and the cathode electrodes 306C and 306D make electrical contact to the heavily to lightly doped regions that extend to the n-type doped supports 352C and 352D.

When a positive (negative) voltage from a voltage source (not shown) is applied between the anode and cathode electrodes (e.g., with the anodes having a higher (lower) voltage than the cathodes), the suspended waveguide core structures will move closer to (farther away from) the adjacent supports. When the spaces between the suspended waveguide cores structures and the center waveguide increase (decrease), the effective refractive index of the guided eigenmode will decrease (increase). The greater the voltage difference (ΔV) between the anode and cathode electrodes, the greater the movement of suspended waveguide core structures. For example, as shown in FIG. 3B, if ΔV2>ΔV1, then there is a larger (lateral) movement of suspended waveguide core structures toward the adjacent support under ΔV2 than under ΔV1. In some implementations, the metal electrodes 306A-306D are fabricated as vias that are formed from a top surface to heavy doping areas in a lower layer.

The examples above show a slot waveguide structure with two slots. FIGS. 4A-4C show example implementations of slot waveguide structures with various numbers of slots. FIG. 4A shows a slot waveguide structure 400 with two suspended waveguide core structures 402A and 402B, and one slot 404. FIG. 4B shows a multiple-slot waveguide structure 410 with four suspended waveguide core structures 412A-412D, and three slots 414A-414C. FIG. 4C shows a slot waveguide structure 420 with five suspended waveguide core structures 422A-422E, and four slots 424A-424D. Any such phase-modulated slot waveguides can be included in an integrated photonic device. In some devices, one or more such phase-modulators can be used in an interferometric arrangement to modulate the amplitude of light that has been phase-shifted and combined interferometrically. For example, a Mach-Zehnder interferometer (MZI) can include, in one or both arms of the MZI, includes a phase-modulated multi-slot waveguide over at least a portion of the arm of the MZI.

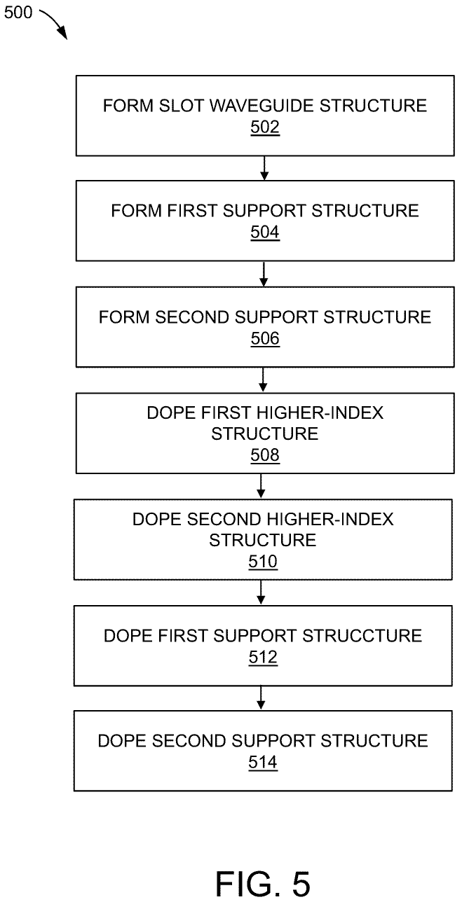

FIG. 5 shows an example of a fabrication procedure 500 for fabricating a slot waveguide optical phase modulator. The procedure 500 includes forming (502) a slot waveguide structure that includes: a first higher-index structure, a second higher-index structure, and one or more slot regions between the first higher-index structure and the second higher-index structure that consist essentially of a gas, a liquid, or a viscous material having a lower index of refraction than the first higher-index structure and the second higher-index structure. The procedure 500 includes forming (504) a first support structure configured to support the first higher-index structure and to enable the first higher-index structure to move to change a dimension of at least one of the one or more slot regions. The procedure 500 includes forming (506) a second support structure configured to support the second higher-index structure and to enable the second higher-index structure to move to change a dimension of at least one of the one or more slot regions. The procedure 500 includes doping (508) the first higher-index structure to include a region that has a first conductivity type. The procedure 500 includes doping (510) the second higher-index structure to include a region that has the first conductivity type. The procedure 500 includes doping (512) the first support structure to include a region that has a second conductivity type opposite from the first conductivity type. The procedure 500 includes doping (514) the second support structure to include a region that has the second conductivity type. These fabrication steps can be performed in any order.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Although the present invention is defined in the attached claims, it should be understood that the present invention can also be defined in accordance with the following sets of embodiments:

Embodiment 1: An apparatus for modulating an optical wave, the apparatus comprising:
a slot waveguide structure that includes:
   a first higher-index structure doped to include a region that has a first conductivity type,
   a second higher-index structure doped to include a region that has the first conductivity type, and
   one or more slot regions between the first higher-index structure and the second higher-index structure that consist essentially of a gas, a liquid, or a viscous material having a lower index of refraction than the first higher-index structure and the second higher-index structure;
a first support structure configured to support the first higher-index structure and to enable the first higher-index structure to move to change a dimension of at least one of the one or more slot regions, where the first support structure is doped to include a region that has a second conductivity type opposite from the first conductivity type; and
a second support structure configured to support the second higher-index structure and to enable the second higher-index structure to move to change a dimension of at least one of the one or more slot regions, where the second support structure is doped to include a region that has the second conductivity type.

Embodiment 2: The apparatus of embodiment 1, wherein the slot waveguide structure comprises a multiple-slot waveguide structure where one or more slot regions comprise two or more slot regions.

Embodiment 3: The apparatus of embodiment 2, wherein the slot waveguide structure further includes: a third higher-index structure that is substantially undoped between the first higher-index structure and the second higher-index structure.

Embodiment 4: The apparatus of embodiment 3, wherein:
the first support structure is configured to enable the first higher-index structure to move to change a dimension of a slot region between the first higher-index structure and the third higher-index structure; and
the second support structure is configured to enable the second higher-index structure to move to change a dimension of a slot region between the second higher-index structure and the third higher-index structure.

Embodiment 5: The apparatus of any of embodiments 1 to 4, further comprising:
an input coupling structure configured to receive the optical wave and to provide coupling between a spatial mode of the optical wave and an eigenmode of the slot waveguide structure; and
an output coupling structure that is configured to provide coupling between the eigenmode of the slot waveguide structure and a spatial mode of a modulated optical wave that has been modulated based at least in part on a change in dimension of at least one of the one or more slot regions during propagation of the optical wave through the slot waveguide structure.

Embodiment 6: The apparatus of any of embodiments 1 to 5, wherein the doped region of the first higher-index structure and the doped region of the second higher-index structure have substantially equal doping concentrations.

Embodiment 7: The apparatus of embodiment 6, wherein the doped region of the first support structure and the doped region of the second support structure have substantially equal doping concentrations.

Embodiment 8: The apparatus of any of embodiments 1 to 7, wherein the doped region of the first support structure is electrically coupled to a first electrode, and the doped region of the second support structure is electrically coupled to a second electrode.

Embodiment 9: The apparatus of embodiment 8, further comprising a voltage source configured to provide a voltage between the first electrode and the second electrode to cause movement that changes a dimension of at least one of the one or more slot regions.

Embodiment 10: The apparatus of any of embodiments 1 to 9, wherein the slot waveguide structure comprises a portion of an arm of an interferometric structure.

Embodiment 11: The apparatus of any of embodiments 1 to 9, comprising an interferometric structure, in which the slot waveguide structure is a portion of an arm of the interferometric structure.

Embodiment 12: The apparatus of embodiment 10 or 11, wherein the slot waveguide structure is configured to modulate a phase of an optical wave propagating in the arm of the interferometric structure.

Embodiment 13: The apparatus of embodiment 12, wherein the interferometric structure is configured to modulate an amplitude of an amplitude of an optical wave propagating in the interferometric structure.

Embodiment 14: The apparatus of embodiment 10 or 11, wherein the interferometric structure comprises a Mach-Zehnder interferometer.

Embodiment 15: The apparatus of any of embodiments 1 to 14 in which the first higher-index structure and the first support structure form an integrated structure.

Embodiment 16: The apparatus of embodiment 15 in which the second higher-index structure and the second support structure form an integrated structure.

Embodiment 17: The apparatus of embodiment 16 in which the first higher-index structure, the second higher-index structure, the first support structure, and the second support structure form an integrated structure.

Embodiment 18: The apparatus of any of embodiments 1 to 16 in which the first support structure and the second support structure form an integrated structure.

Embodiment 19: An apparatus comprising:
a slot waveguide structure that includes:
   two or more higher-index structures each doped to include a region that has a first conductivity type, and
   one or more slot regions between the two or more higher-index structures having a lower index of refraction as compared to that of the two or more higher-index structures; and
support structures configured to support corresponding higher-index structures and to enable the corresponding higher-index structures to move to change a dimension of at least one of the one or more slot regions, in which each support structure is doped to have a second conductivity type that is opposite the first conductivity type.

Embodiment 20: The apparatus of embodiment 19, comprising electrodes configured to enable a voltage to be applied across the region in the high-index structure that is doped to have a first conductivity type and the region in the corresponding support structure that is doped to have the second conductivity type.

Embodiment 21: Δ system comprising:
a processor unit comprising:
   a light source configured to provide a plurality of light outputs;
   a plurality of optical modulators coupled to the light source and the first unit, the plurality of optical modulators being configured to generate an optical input vector by modulating the plurality of light outputs provided by the light source based on a plurality of modulator control signals, the optical input vector comprising a plurality of optical signals; and
   a matrix multiplication unit coupled to the plurality of optical modulators, the matrix multiplication unit being configured to transform the optical input vector into an output vector based on a plurality of weight control signals;
wherein at least one of the optical modulators comprises the apparatus of any of embodiments 1 to 20.

Embodiment 22: The system of embodiment 21 in which each of the optical modulators comprises the apparatus of any of embodiments 1 to 20.

Embodiment 23: An optical processor that comprises a plurality of optical modulators, in which at least one of the optical modulators comprises the apparatus of any of embodiments 1 to 20.

Embodiment 24: The optical processor of embodiment 23 in which each of the plurality of optical modulators comprises the apparatus of any of embodiments 1 to 20.

Embodiment 25: A system comprising at least one of a robot, an autonomous vehicle, an autonomous drone, a medical diagnosis system, a fraud detection system, a weather prediction system, a financial forecast system, a facial recognition system, a speech recognition system, or a product defect detection system, wherein the at least one of a robot, an autonomous vehicle, an autonomous drone, a medical diagnosis system, a fraud detection system, a weather prediction system, a financial forecast system, a facial recognition system, a speech recognition system, or a product defect detection system comprises the apparatus of any of embodiments 1 to 20.

Embodiment 26: A method for fabricating an optical modulator, the method comprising:
forming a slot waveguide structure that includes:
   a first higher-index structure,
   a second higher-index structure, and
   one or more slot regions between the first higher-index structure and the second higher-index structure that consist essentially of a gas, a liquid, or a viscous material having a lower index of refraction than the first higher-index structure and the second higher-index structure;
forming a first support structure configured to support the first higher-index structure and to enable the first higher-index structure to move to change a dimension of at least one of the one or more slot regions;
forming a second support structure configured to support the second higher-index structure and to enable the second higher-index structure to move to change a dimension of at least one of the one or more slot regions;
doping the first higher-index structure to include a region that has a first conductivity type;
doping the second higher-index structure to include a region that has the first conductivity type;
doping the first support structure to include a region that has a second conductivity type opposite from the first conductivity type; and
doping the second support structure to include a region that has the second conductivity type.

Embodiment 27: The method of embodiment 26, wherein forming the slot waveguide structure includes: forming a plurality of holes within a portion of the first support structure, forming a plurality of holes within a portion of the second support structure, and providing a gas through at least some of the plurality of holes to etch a portion of material from which the first higher-index structure and the second higher-index structure are formed, to enable movement of the first higher-index structure and the second higher-index structure.

Embodiment 28: The method of embodiment 27, wherein the doping of the first higher-index structure, the second higher-index structure, the first support structure, and the second support structure occur before the plurality of holes are formed within portions of the first and second support structures.

Embodiment 29: A method of modulating an optical wave, the method comprising
propagating an optical wave along a slot waveguide structure that includes:
   two or more suspended waveguide core structures that define one or more slot
   regions between the suspended waveguide core structures; and
modulating the optical wave by generating an electromagnetic force to cause the two or more suspended waveguide core structures to move and modify a dimension of the one or more slot regions between the suspended waveguide core structures and modify an effective refractive index of the slot waveguide structure.

Embodiment 30: The method of embodiment 29 in which the slot waveguide structure comprises support structures each configured to support a respective suspended waveguide core structure, and generating the electromagnetic force comprises generating a repulsion force to cause a suspended waveguide core structure to move away from the corresponding support structure.

Embodiment 31: The method of embodiment 29 in which the slot waveguide structure comprises support structures each configured to support a respective suspended waveguide core structure, and generating the electromagnetic force comprises generating an attractive force to cause a suspended waveguide core structure to move towards the corresponding support structure.

Embodiment 32: The method of any of embodiments 29 to 31 in which each suspended waveguide core structure includes a region that is doped to have a first conductivity type, and the corresponding support structure includes a region that is doped to have a second conductivity type that is opposite the first conductivity type.

Embodiment 33: An apparatus comprising:
a slot waveguide structure that includes:
   a first higher-index structure doped to include a region that has a first conductivity type,
   a second higher-index structure doped to include a region that has the first conductivity type, and
   one or more slot regions between the first higher-index structure and the second higher-index structure that have a lower index of refraction than the first higher-index structure and the second higher-index structure;
a first support structure configured to support the first higher-index structure and to enable the first higher-index structure to move to change a dimension of at least one of the one or more slot regions, where the first support structure is doped to include a region that has a second conductivity type different from the first conductivity type; and
a second support structure configured to support the second higher-index structure and to enable the second higher-index structure to move to change a dimension of at least one of the one or more slot regions, where the second support structure is doped to include a region that has the second conductivity type.

1. An apparatus for modulating an optical wave, the apparatus comprising:
a slot waveguide structure that includes:
a first higher-index structure doped to include a region that has a first conductivity type,
a second higher-index structure doped to include a region that has the first conductivity type, and
one or more slot regions between the first higher-index structure and the second higher-index structure that consist essentially of a gas, a liquid, or a viscous material having a lower index of refraction than the first higher-index structure and the second higher-index structure;
a first support structure configured to support the first higher-index structure and to enable the first higher-index structure to move to change a dimension of at least one of the one or more slot regions, where the first support structure is doped to include a region that has a second conductivity type opposite from the first conductivity type; and
a second support structure configured to support the second higher-index structure and to enable the second higher-index structure to move to change a dimension of at least one of the one or more slot regions, where the second support structure is doped to include a region that has the second conductivity type.

2. The apparatus of claim 1, wherein the slot waveguide structure comprises a multiple-slot waveguide structure where one or more slot regions comprise two or more slot regions.

3. The apparatus of claim 2, wherein the slot waveguide structure further includes: a third higher-index structure that is substantially undoped between the first higher-index structure and the second higher-index structure.

4. The apparatus of claim 3, wherein:
the first support structure is configured to enable the first higher-index structure to move to change a dimension of a slot region between the first higher-index structure and the third higher-index structure; and
the second support structure is configured to enable the second higher-index structure to move to change a dimension of a slot region between the second higher-index structure and the third higher-index structure.

5. The apparatus of claim 1, further comprising:
an input coupling structure configured to receive the optical wave and to provide coupling between a spatial mode of the optical wave and an eigenmode of the slot waveguide structure; and
an output coupling structure that is configured to provide coupling between the eigenmode of the slot waveguide structure and a spatial mode of a modulated optical wave that has been modulated based at least in part on a change in dimension of at least one of the one or more slot regions during propagation of the optical wave through the slot waveguide structure.

6. The apparatus of claim 1, wherein the doped region of the first higher-index structure and the doped region of the second higher-index structure have substantially equal doping concentrations.

7. The apparatus of claim 6, wherein the doped region of the first support structure and the doped region of the second support structure have substantially equal doping concentrations.

8. The apparatus of claim 1, wherein the doped region of the first support structure is electrically coupled to a first electrode, and the doped region of the second support structure is electrically coupled to a second electrode.

9. The apparatus of claim 8, further comprising a voltage source configured to provide a voltage between the first electrode and the second electrode to cause movement that changes a dimension of at least one of the one or more slot regions.

10. The apparatus of claim 1, wherein the slot waveguide structure comprises a portion of an arm of an interferometric structure.

11. The apparatus of claim 1, comprising an interferometric structure, in which the slot waveguide structure is a portion of an arm of the interferometric structure.

12. The apparatus of claim 11, wherein the slot waveguide structure is configured to modulate a phase of an optical wave propagating in the arm of the interferometric structure.

13. The apparatus of claim 12, wherein the interferometric structure is configured to modulate an amplitude of an amplitude of an optical wave propagating in the interferometric structure.

14. The apparatus of claim 11, wherein the interferometric structure comprises a Mach-Zehnder interferometer.

15. The apparatus of claim 1 in which the first higher-index structure and the first support structure form an integrated structure.

16. The apparatus of claim 15 in which the second higher-index structure and the second support structure form an integrated structure.

17. The apparatus of claim 16 in which the first higher-index structure, the second higher-index structure, the first support structure, and the second support structure form an integrated structure.

18. The apparatus of claim 1 in which the first support structure and the second support structure form an integrated structure.

19. An apparatus comprising:
a slot waveguide structure that includes:
two or more higher-index structures each doped to include a region that has a first conductivity type, and
one or more slot regions between the two or more higher-index structures having a lower index of refraction as compared to that of the two or more higher-index structures; and
support structures configured to support corresponding higher-index structures and to enable the corresponding higher-index structures to move to change a dimension of at least one of the one or more slot regions, in which each support structure is doped to have a second conductivity type that is opposite the first conductivity type.

20. The apparatus of claim 19, comprising electrodes configured to enable a voltage to be applied across the region in the high-index structure that is doped to have a first conductivity type and the region in the corresponding support structure that is doped to have the second conductivity type.

21-33. (canceled)
